(19) United States
(12) Patent Application Publication
(10) Pub. No.: US 2003/0041165 A1
(43) Pub. Date: Feb. 27, 2003

(54) System and method for group video teleconferencing using a bandwidth optimizer

(76) Inventors: Percy L. Spencer, Santa Cruz, CA (US); Max E. Montgomery, Santa Cruz, CA (US); Petrus Hubertus Weyzen, Santa Cruz, CA (US); Jeremy Egenberger, Modesto, CA (US); Don Fossgreen, Scotts Valley, CA (US)

Correspondence Address: McDermott, Will & Emery, 2700 Sand Hill Road, Menlo Park, CA, 94025, US

(21) Appl. No.: 10/045,133

(22) Filed: Oct. 23, 2001

Related U.S. Application Data
(63) Continuation of application No. 09/938,721, filed on Aug. 24, 2001.

(51) Int. Cl. G06F 15/16

(52) U.S. Cl. 709/233

(57) ABSTRACT

A system for sending and receiving multimedia transmissions over a network includes two or more clients and a server. Each client is connected to the network and generates and receives audio and video data via the network. The server receives the audio and video data from the clients and sends the audio and video data to the clients. During the transmission of the audio and video data, the client and server dynamically determine the rate at which to transmit the audio and video data.

### CROSS REFERENCE TO RELATED APPLICATION

This application is a continuation in part of U.S. patent application Ser. No. 09/938,721, “System and Method for Group Video Teleconferencing with Variable Bandwidth,” by Spencer, et al, filed Aug. 24, 2001, the entirety of which is herein incorporated by reference.

### BACKGROUND

1. Field of the Invention

The present invention relates to video-teleconferencing, and more particularly to varying transmission rate based on availability of bandwidth during video-teleconferencing.

2. Background of the Invention

Current video teleconferencing technology is plagued with comparatively high latency, low efficiency, and poor scalability. One reason for this is that current technologies use a “lowest common bandwidth” method for determining the speed of transmission and packet size. Thus, if multiple clients are conferencing simultaneously, the transmission of the video data is only as fast as the lowest bandwidth will allow. As a result, in a conference in which some clients are using relatively slow dialup connections, while others are using T1, DSL, or similar broadband connections, those clients using broadband connections will receive data only at the rate of the dialup connection, thus under utilizing their capabilities.

Current video teleconferencing techniques use the store and forward method for transmitting video frames. As video frames are generated, they are stored in their entirety on the generating computer. The frames are then forwarded to the server where they are again stored in their entirety and forwarded to the receiving computer. This requires large amounts of available memory on the server and increases the workload of the server. As a result, conventional systems have poor scalability and increased latency.

Current video teleconferencing techniques often encounter difficulties when trying to pass through a firewall or proxy server. Firewalls are not compatible with data sent using UDP (User Datagram Protocol), a protocol that is commonly used by video teleconferencing technologies. Proxy servers are used to filter requests and as a result, may filter out certain types of traffic often including video conferencing traffic.

In view of the foregoing limitations, there is a need for a video teleconferencing system that takes better advantage of the bandwidth capabilities of all clients, provides reduced latency and improved scalability and is compatible with firewalls and proxy servers.

### SUMMARY OF THE INVENTION

The present invention reduces latency and increases efficiency of multimedia group conferencing by providing a system for dynamically transmitting data that includes a tiered-server architecture. Clients using the system for multimedia group conferencing are connected to a network and transmit and receive audio and video data via the network. When a client accesses the system, one of the servers determines the maximum bandwidth available for the connection to that client. The server then establishes an appropriate rate of transmission and packet size of the data being transmitted in order to take full advantage of the available bandwidth. During the transmission of the multimedia data, the bandwidth optimizer adjusts the transmission rate while monitoring actual round trip transmission times and rate of packet loss in order to determine the most efficient transmission rate. If the bandwidth optimizer detects a backlog, it lowers the rate of data transmission by decreasing the packet size and transmission interval for the data. If the bandwidth optimizer detects no backlog, then it gradually increases the rate of data transmission until a backlog is again detected.

### BRIEF DESCRIPTION OF THE DRAWINGS

FIG. 1 is a network diagram including an exemplary embodiment of the present invention.

FIG. 2 is a multimedia streaming diagram in accordance with an exemplary embodiment of the present invention.

FIG. 3 is a block diagram of a room server according to an exemplary embodiment of the present invention.

FIG. 4 is a block diagram of a client according to an exemplary embodiment of the present invention.

FIG. 5 is a diagram of a threading model according to an exemplary embodiment of the present invention.

FIG. 6 is a flow chart of dynamic data transmission according to an exemplary embodiment of the present invention.

FIG. 7 is a block diagram of an exemplary embodiment of a bandwidth optimizer.

FIG. 8 is a flow diagram of an exemplary embodiment of the bandwidth optimizer process.

FIG. 9 is a depiction of an exemplary embodiment of a latency timeline as used by the present invention to determine transmission latency.

FIG. 10 is a block diagram depicting an exemplary embodiment of a bandwidth indicator as used by the present invention.

FIG. 11 shows an exemplary embodiment of the user interface for the bandwidth meter.

FIG. 12 is a screen shot of an exemplary embodiment of a user interface including a microphone queue.

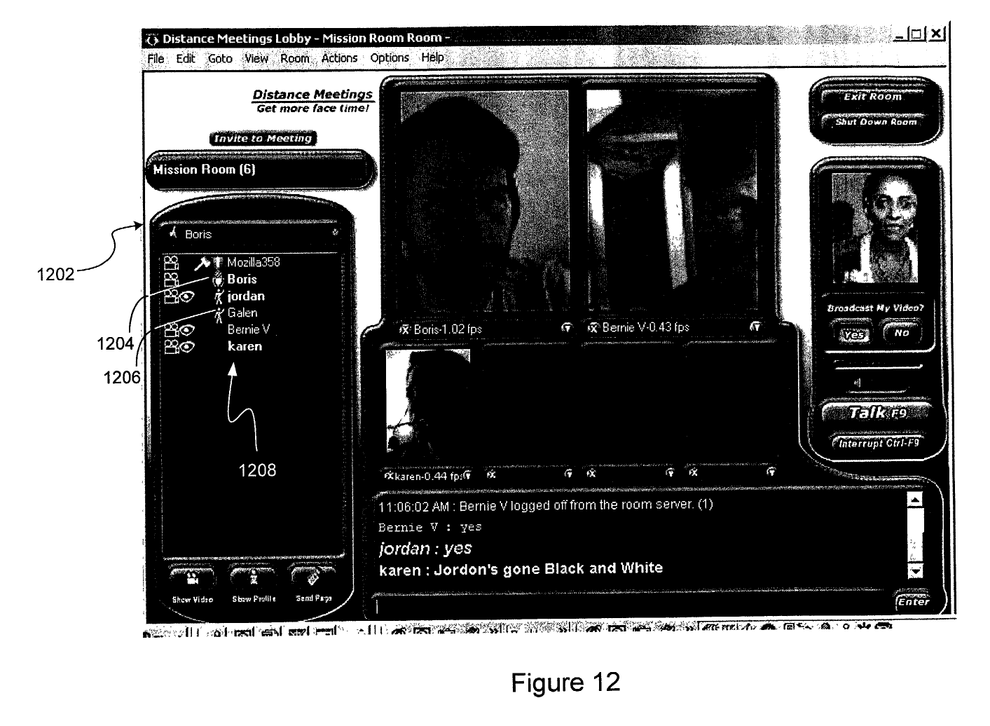

FIG. 13 is a screen shot of an exemplary embodiment of a contact list as used with an instant meeting feature.

### DETAILED DESCRIPTION OF THE INVENTION

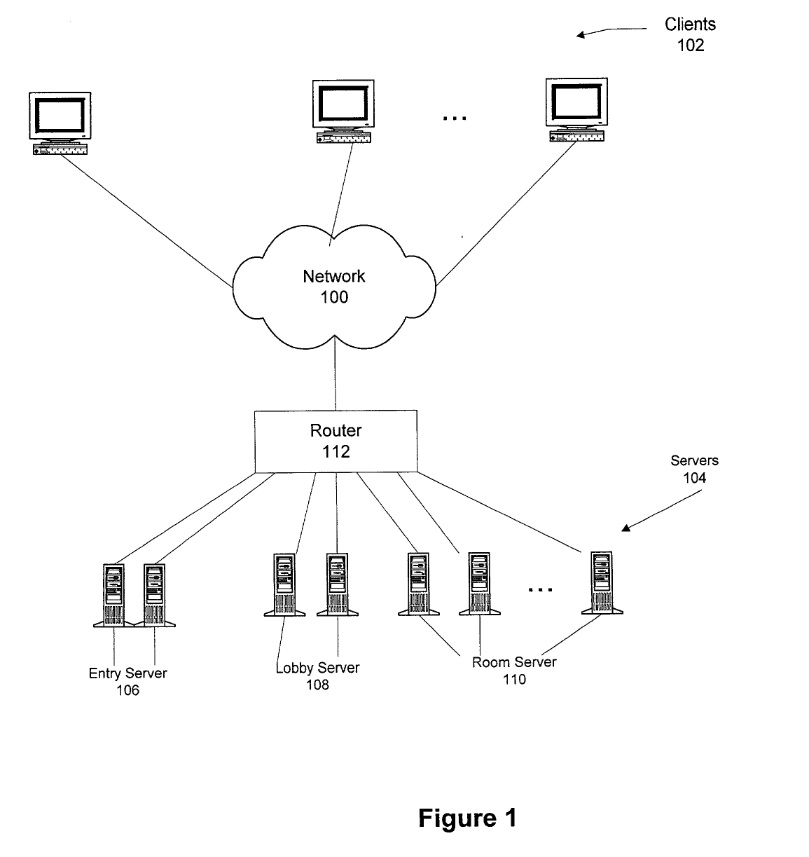

FIG. 1 is a diagram of an exemplary embodiment of a system including the present invention. The system includes a network 100, a router 112, one or more clients 102, and one or more servers 104. In an exemplary embodiment, two or more of the clients 102 send and receive multimedia data to each other via the network 100. The servers 104 facilitate any multimedia functionality that may be required for the accurate transmission of the data from client to client. The router 112 may be any commonly used routing device that facilitates the data flow to and from the servers 104. In an exemplary embodiment, a tiered-server architecture includes some or all of entry servers 106, lobby servers 108, and room servers 110 (collectively, servers 104.) The metaphor of lobbies and rooms facilitates load balancing and a place-oriented conferencing environment. Instead of choosing to conference with individuals, each client 102 may choose to enter a lobby and a room within that lobby. Similar to an online chat room, each client 102 is able to send audio, video and data to one or more other clients within a room.

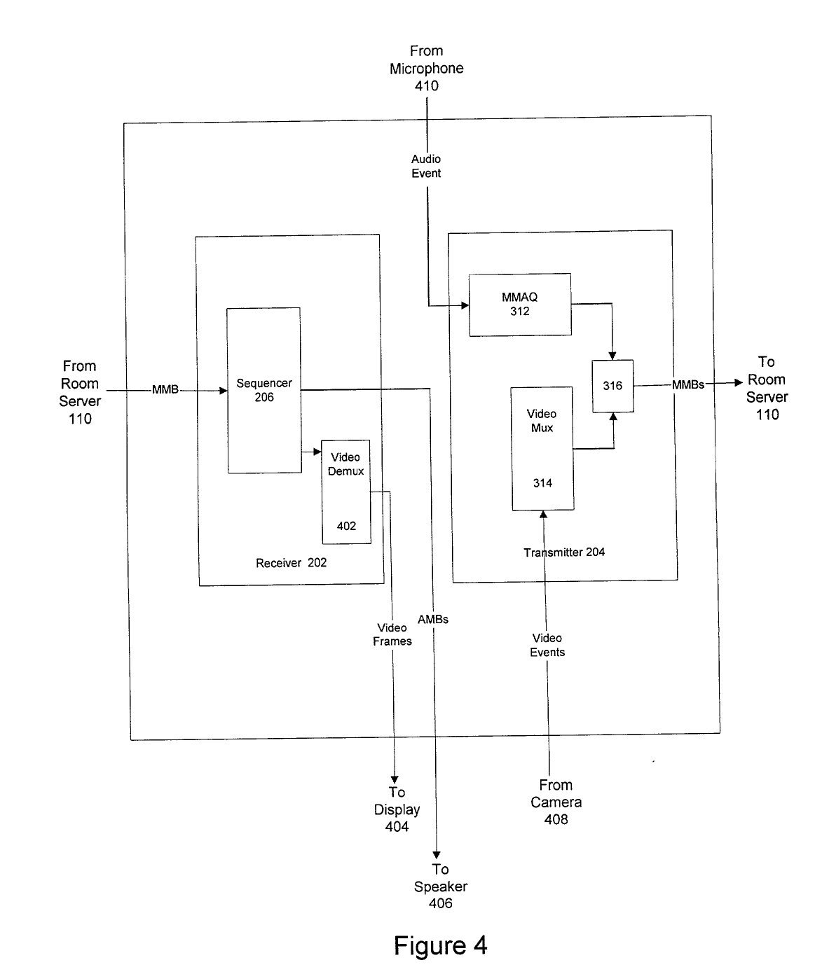

The servers 104 are connected to the clients 102 via the network 100. In a typical embodiment, the network 100 may be the Internet, a proprietary network or an intranet, however other networks may also be used and the particular form of network is not limiting. Alternately, in some embodiments, the servers 104 and clients 102 may communicate indirectly or directly without passing through the network 100. The client 102 may have any number of configurations of audio and video equipment to facilitate sending and receiving audio and video signals. This equipment may include a video display unit, speakers, a microphone, a camera, and a processing unit running suitable software to implement the conferencing functionality described below. An exemplary configuration of a client 102 is described in greater detail with the discussion of FIG. 4, below.

To send and receive multimedia data, clients 102 exchange information with servers 104. An exemplary embodiment includes one or two entry servers 106, however, the system is not limited to this number of entry servers 106. The entry servers 106 are responsible for the administrative functionality of logging-in clients 102, which includes providing password encryption during the log-in process. The entry servers 106 are also responsible for maintaining a directory of available lobbies, allowing each client 102 to choose a lobby, and ensuring that that client 102 has permission to enter that lobby. The entry servers 106 are easily clustered, since the only state information contained in the entry servers 106 is the directory of available lobbies. The entry servers 106 also assist in the client-initiated analysis of bandwidth, latency, and protocol availability. When a client logs in, the client 102 and entry server exchange a test transmission that together with other requested information establishes the bandwidth of the connection to and from the client 102 and determines whether UDP will work as a transmission protocol. If the use of UDP is not restricted by firewalls or proxy servers, then future transmissions during the session will be sent using UDP. If, however, the use of UDP is restricted, then future transmissions will be sent using TCP (transmission control protocol.)

The lobby servers 108 send identifying information to the entry servers 106. This information includes a list of clients that do not have access to the lobby. The lobby servers 108 also perform a load balancing function. If a client 102 requests the creation of a new room, the lobby server 108 creates the room on the room server 110 that has the least load. In an exemplary embodiment, any client 102 that is logged into a lobby may request the creation of a new room. Alternatively, the creation of new rooms may be restricted to predetermined clients 102 or clients that fulfill certain criteria. For instance, requesting the creation of a new room may be restricted to those clients 102 who have provided billing information such that the use of the room by any client 102 may be charged to the creating client 102. As another example, clients 102 may be restricted from creating rooms that contain controversial, obscene or otherwise restricted material.

In an exemplary embodiment, the client 102 requesting the creation of a new room, or the moderator, is assigned special control privileges over the conference. For example, the moderator may prevent certain clients 102 from continuing to participate in the conference, may control which clients 102 have access to certain types of information, or may close the room. Moderators may also delegate the special privileges to another client 102. In an exemplary embodiment, a lobby server 108 may support a plurality of room servers 110, for example up to seven or more room servers 110. From the lobby, a client 102 has an option of requesting the creation of a new room or entering an existing room.

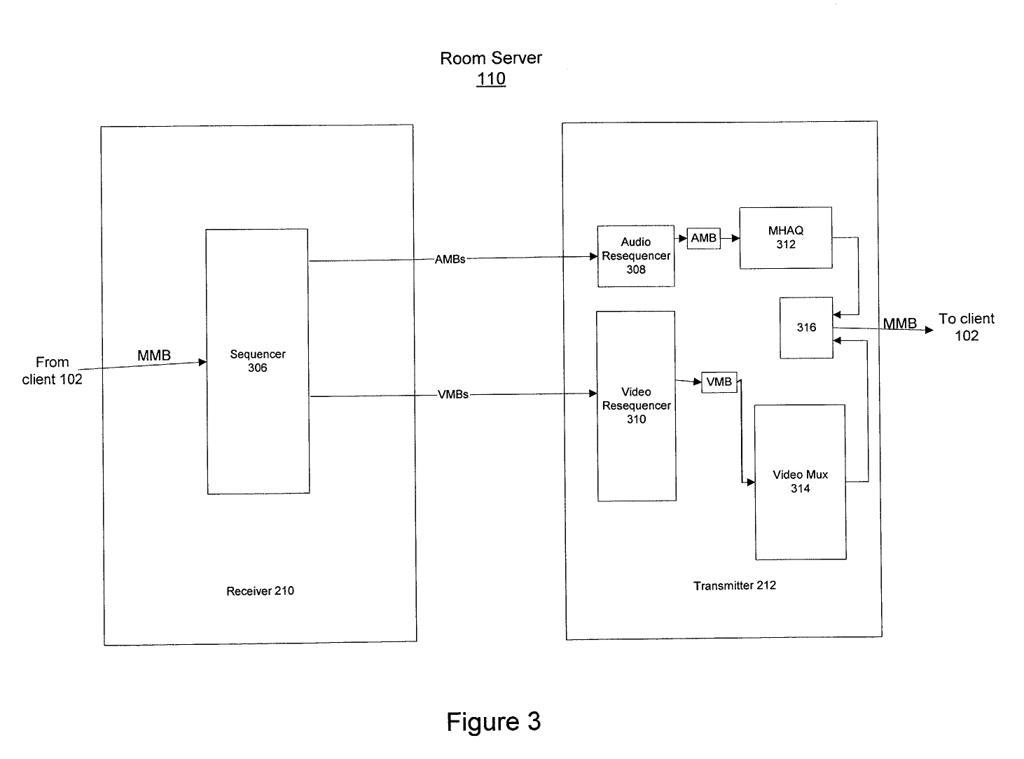

In an exemplary embodiment, the room servers 110 facilitate the multimedia functionality of the system. The room server 110 is discussed in greater detail in the description of FIG. 3, below. FIG. 1 shows only one example of a possible architecture and the invention is not limited to the exemplary architecture illustrated in FIG. 1. For example, the overall number of servers 104 may vary as may the number of entry servers 106, lobby servers 108 or room servers 110. There may also be other types of servers included in the system. In an alternate embodiment, the system may operate without router 112. Also, the clients 102 and servers 104 may be directly connected, without an intermediate network connection.

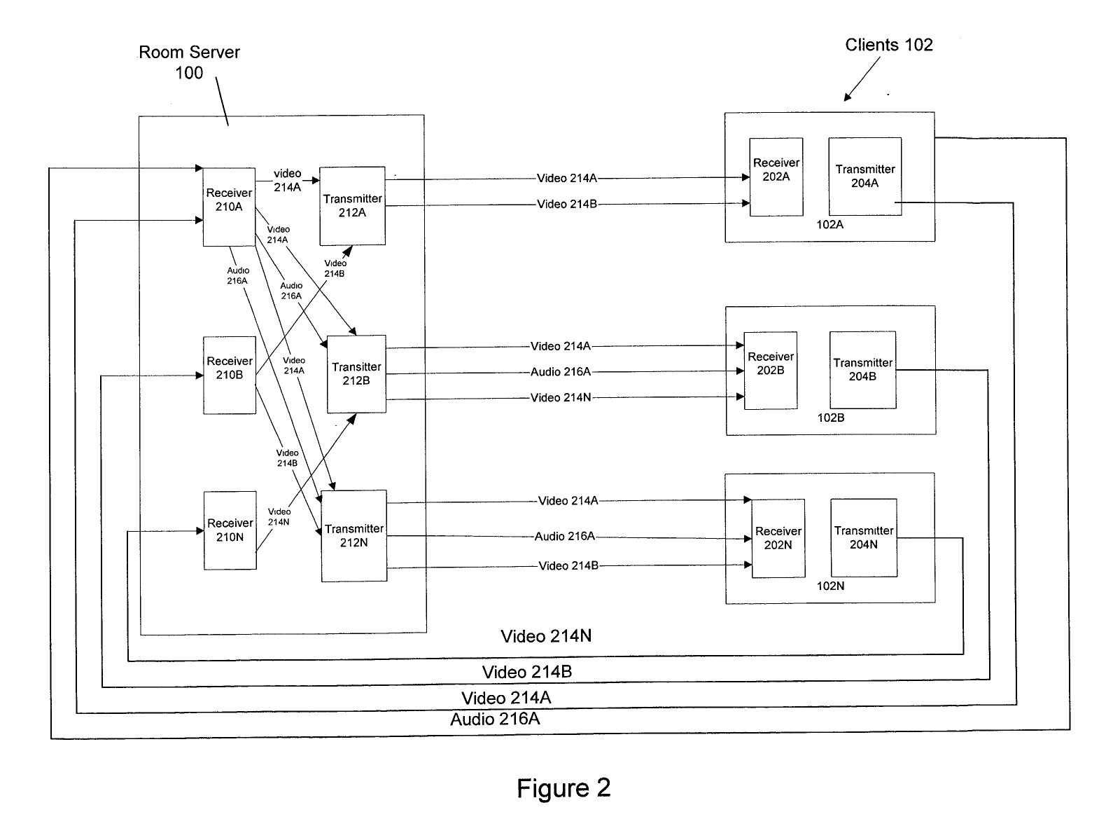

FIG. 2 is a multimedia streaming diagram in accordance with an exemplary embodiment of the present invention. The clients 102A, 102B, 102N (collectively clients 102) exchange audio and video data with each other via the room server 110. Each client 102 may include a transmitter 204 and a receiver 202. The room server 110 establishes a unique receiver 210 and transmitter 212 for each client 102 that is transmitting data through the room server 110. The clients 102 are connected to the room server 110 via a network 100, not shown in FIG. 2. The clients 102 and room server 110 are described in greater detail in the discussion of FIGS. 3 and 4, below.

The audio data 216 and video data 214 are sent from the transmitter 204 of the generating client 102 to the receiver 210 for that client 102 at the room server 110. In an exemplary embodiment, each client 102 chooses which video and audio to view and hear. These choices are facilitated through the use of subscriber lists and subscription lists. The subscriber lists are used in conjunction with receivers 202, 210 to redistribute data to other clients in a room. Each receiver 202, 210 is grouped with one subscriber list for audio data and one subscriber list for video data. The subscriber list identifies those clients who have subscribed to a given audio stream or video stream. The subscription list is used in conjunction with the transmitters 204, 212 to correlate video streams with specific video channels so that this data can be multiplexed. Each transmitter 204, 212 is grouped with one subscription list for audio and one subscription list for video. The subscription list identifies those clients whose audio and video will be transmitted to the clients on the subscriber list. Thus, clients on the subscriber list will be receiving audio and video and clients on the subscription list will be transmitting audio and video. In an exemplary embodiment, the audio subscription list may contain only one entry since each client 102 may hear only one audio stream at a time. In an alternate embodiment, the system may support multi-channel audio, in which case the audio streams would be multiplexed in a manner similar to the video streams. The video subscription list may contain up to eight entries, one for each video window that may be simultaneously displayed.

Based on the information in the subscriber lists and subscription lists, the receivers 210 in the room server 110 send video and audio streams 214, 216 to the transmitters 212 of the receiving clients 102 in the room server 110. The transmitters 212 then send the video and audio to the respective clients 102. The transmission of the multimedia data is discussed in greater detail in the description of FIGS. 3 and 4, below.

In the example shown in FIG. 2, client 102A is transmitting video data 214A and audio data 216A. The other two clients shown, clients 102B and 102N are transmitting video data 214B and 214N respectively. Client 102A is receiving its own video 214A and video 214B from client 102B. As a result, the video subscription list for transmitter 212A will contain clients 102A and 102B, and the video subscriber lists for both receiver 202A and 202B will contain client 102A. Note that in the embodiment shown, the video 214A of client 102A is transmitted over the network 100 to the room server 110 and back. In an alternate embodiment, client 102A may view a local video image as direct feedback without video 214A being transmitted over the network and back. This direct feedback reduces latency and increases scalability. Client 102B is receiving video 214A and audio 216A from client 102A and video 214N from client 102N. Client 102N is receiving video 214A and audio 216A from client 102A and video 214B from client 102B. When clients 102B and 102N first request to see and hear this audio and video data, the relevant subscription and subscriber lists are updated.

Transmitter 204A at client 102A sends the audio stream 216A and video stream 214A generated at client 102A to receiver 210A at the room server 110. Receiver 210A sends the audio stream 216A to transmitter 212B and transmitter 212N for transmission to clients 102B and 102N respectively. Receiver 210A sends the video stream 214A to transmitters 212A, 212B, and 212N for transmission to clients 102A, 102B, and 102N respectively. Transmitter 204B at client 102B sends the video stream 214B generated at client 102B to receiver 210B at the room server 110. Receiver 210B sends the video stream 214B to transmitters 212A and 212N for transmission to clients 102A and 102N respectively. Transmitter 204N sends video stream 214N generated at client 102N to receiver 210N at the room server 110. Receiver 210N sends the video stream 214N to transmitter 212B for transmission to client 102B.

Transmitter 212A sends video 214A and 214B to receiver 202A at client 102A. Transmitter 212B sends video 214A and 214N and audio 216A to receiver 202B at client 102B. Transmitter 212N sends video 214A and 214B and audio 216A to receiver 202N at client 102N. These transmissions from transmitters 212A, 212B, 212N are governed by the respective subscription lists for those transmitters.

In addition to video and audio transmissions, the clients may also transmit data such as slide show presentations, text documents, photographic images, music files, etc. Like the video and audio streams depicted in FIG. 2, the data stream may be sent from any client 102 to one or more receiving clients 102. FIG. 2 depicts three clients 102, however, there may be any number of clients 102 each with a unique transmitter 212 and receiver 210 at the room server 110.

FIG. 3 is a block diagram of a room server according to an exemplary embodiment of the present invention. The room server 110 may include zero, one or more pairs of receivers 210 and transmitters 212. In an exemplary embodiment, the receiver 210 and transmitter 212 are implemented in software and the room server 110 creates a unique receiver 210 and transmitter 212 for each client 102 that is sending or receiving multimedia data. The receiver 210 may include a sequencer 306. The transmitter 212 may include some or all of an audio resequencer 308, a video resequencer 310, a multimedia audio queue 312, a video multiplexer 314, and a packet encoder 316.

Each receiver 210 is connected to the network 100 to receive multimedia data from a client 102. The receiver 210 is also connected to one or more transmitters 212. The receiver 210 transfers the data received from the client 102 to the transmitter 212. The transmitter 212 is also connected to the network 100 and data transferred by the receiver 210 to the transmitter 212 is transmitted over the network 100 to the receiving client 102.

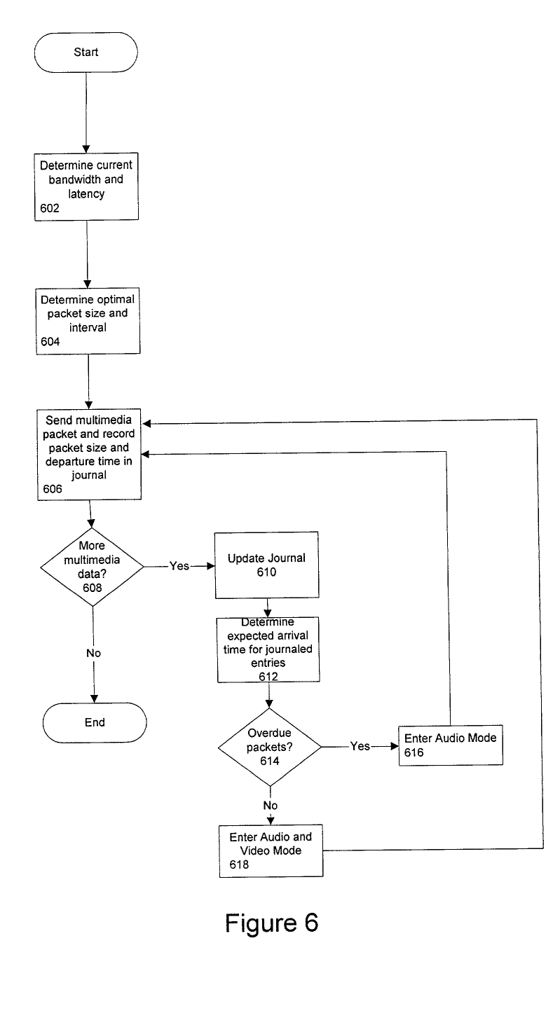

The room server 110 receives data in the form of multimedia blocks from the sending client 102. In an exemplary embodiment, a multimedia block is a type of data packet that includes some or all of a sequence number, audio frames, video fragments, a video channel, a receipt, video parameters, audio parameters, a video end flag, and an audio end flag. The sequence number is used to reorder the multimedia blocks if they contain audio or video data. If the multimedia block contains audio data, this data would be in the form of an audio frame. If the multimedia block contains video data, this data would be in the form of a video fragment. The video fragment is a data structure that may represent the start, middle, or end of a video frame. The video fragment may also be an entire video frame or a special value indicating that a video fragment has been lost during a prior transmission. The video channel is the channel assigned to the video fragment, if there is video data. The receipt is the sequence number of the most recent multimedia block received by the other party. The receipt is used in determining the allocation of bandwidth as discussed in the description of FIG. 6, below. The video and audio parameters are transmitted as part of the multimedia block when starting to send new video or audio data. The video and audio end flag indicates the end of an audio or video transmission. For video data, parameters and end flag include starting to send data on a new channel or closing a channel at the end of a video stream. In one embodiment, audio data may have a higher priority than video data, thus ensuring the accuracy of the audio data if some data cannot be transmitted. In this case, multimedia blocks would contain all available audio data. In an exemplary embodiment, the sequencer 306 receives the multimedia blocks and separates them into audio media blocks and video media blocks. The sequencer 306 also uses the sequence numbers for the multimedia blocks received over the network 100 in order to ensure the proper ordering of multimedia blocks. The sequencer 306 may temporarily store out of sequence multimedia blocks pending the receipt of the next anticipated multimedia block. If the missing multimedia block is not received before storage space is exhausted, then the sequencer 306 assumes the multimedia block is lost.

The audio media blocks are transferred by the room server 110 from the sequencer 306 to the audio resequencer 308 of the transmitter 212. Like the sequencer 306, the audio resequencer 308 puts the audio data from the audio media blocks into the proper order, i.e., the order in which they were generated. In an exemplary embodiment, the audio resequencer 308 differs from the sequencer 306 in that it does not handle packet loss. As a result, it provides more temporary storage for packets that are received out of sequence. From the audio resequencer 308, the sequenced audio media blocks are sent to the multimedia audio queue 312. The multimedia audio queue 312 buffers the audio media blocks until there is available bandwidth at the receiving client 102 to accept additional multimedia data. The audio media blocks are then combined with the video media blocks to form multimedia blocks, which are then sent to the receiving client 102 via the network 100 or any established transmission connection.

The room server 110 transfers video media blocks to a video resequencer 310. In an exemplary embodiment, there is one video resequencer for each of eight video channels. Each channel handles video data displayed in a unique display window on the display 404 of the client 102. Thus, in the exemplary embodiment with eight video channels, there may be up to eight simultaneously displayed video streams. The video media blocks are transferred to the video multiplexer 314.

The video multiplexer 314 contains a video queue for each video channel. The video queues are FIFO (first in first out) and store video fragments. The video fragment may be a whole video frame, a start of a video frame, a middle of a video frame, an end of a video frame, or a special value that represents a lost video fragment. In an exemplary embodiment, only certain sequences of video fragments may be input into the video queue. For example, a ‘start’ may be followed by a ‘middle,’ which may be followed by an ‘end,’ however, a ‘start’ may not be followed by another ‘start.’ The sequencing of the fragments in the video queue facilitates reassembly of video frames from the fragments. An entire video frame or a certain number of bytes of a video frame may be output from the video queue. As an example, if a video queue were storing a 200-byte ‘start’ fragment, then the queue may output, on request, a 100-byte ‘start’ fragment, leaving a 100-byte ‘middle’ fragment as the next fragment in the queue.

The video queue in the video multiplexer 314 functions as a buffer for the video data. As video media blocks are received in order by the video multiplexer 314, they are assembled into complete video frames in the video queue. Once an entire video frame has been assembled, if there is no available bandwidth in the connection to the receiving client 102 for accepting the video data, the video queue drops the frame. As bandwidth becomes available in the connection to the receiving client 102, video media blocks are sent to packet encoder 316 where they are combined with the audio media blocks to form multimedia blocks. The multimedia blocks are sent to the receiving client 102 via network 100 or via any established transmission connection.

FIG. 4 is a block diagram of a client 102 according to an exemplary embodiment of the present invention. In one embodiment, the client 102 includes a receiver 202, a transmitter 204, a display 404, a speaker 406, a camera 408, and a microphone 410. Each client 102 is capable of both transmitting and receiving multimedia data.

On the transmitting side, the camera 408 generates video events and the microphone 410 generates audio events. The video events are sent to the video multiplexer 314. Like the video multiplexer 314 at the room server 110, the video multiplexer 314 at the client has multiple channels to handle multiple video signals. Thus, the client 102 may contain multiple video cameras. Also like the video mulitplexer 314 at the room server 110, the video multiplexer 314 at the client 102 contains a video queue for each channel, which is used for sequencing and dropping video frames to reduce bandwidth requirement.

The audio events are sent from the microphone 410 to the multimedia audio queue 312. As bandwidth becomes available to send the data, video media blocks and audio media blocks are sent to packet encoder 316 where they are combined to form multimedia blocks. The multimedia blocks are sent to the room server 110 via the network 100, or any established transmission connection.

On the receiving side, the receiver 202 receives multimedia blocks via the network 100 from the room server 110. The sequencer 306 in the receiver 202 orders the multimedia blocks into the proper order and separates them into video media blocks and audio media blocks. The audio media blocks are sent to the speakers 406 where they are converted to into sound, which may be generated in either analog or digital form depending on the particular implementation. The video media blocks are sent to the video demultiplexer 402 where they are broken down into individual video frames. Similar to video multiplexer 314, video demultiplexer 402 contains a video queue that is used for assembling video frames and dropping video frames. The video frames are sent to the video display 404 where they are displayed in a conventional manner.

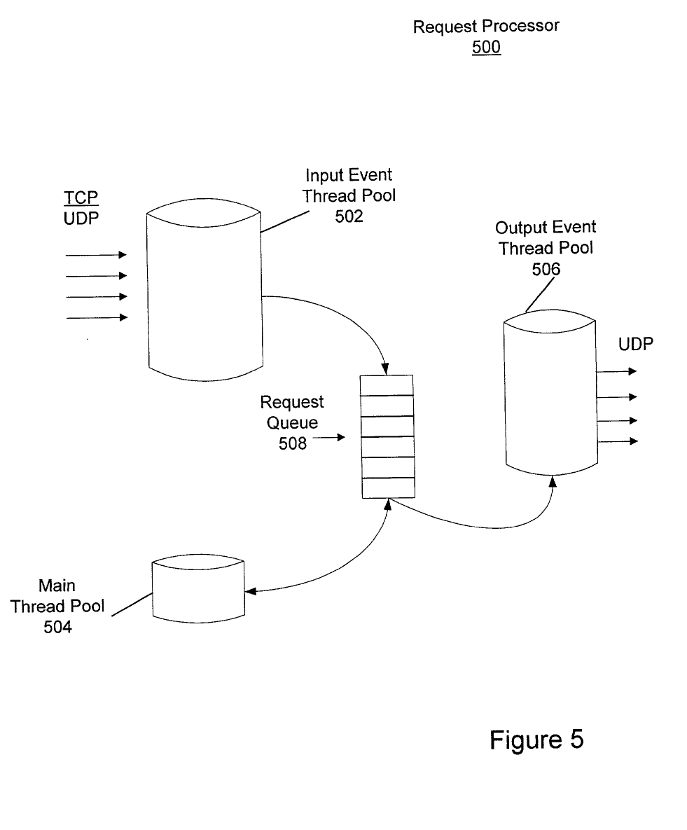

FIG. 5 is a diagram of a threading model according to an exemplary embodiment of the present invention. In addition to multimedia transmissions, receivers 210 and transmitters 212 in the room server 110 also send and receive requests to and from their respective clients 102. These events may include requests to send audio or video to specific clients, request to view the video of specific clients, requests to block clients from viewing video, etc. Clients that are assigned the position of moderator may make requests that are limited to the moderator. Examples of these requests include requests to eject a client, requests to set the privileges of certain clients to have access to certain data types, requests to close a room, or requests to make another client assume the position of moderator.

In an exemplary embodiment as shown in FIG. 5, a request processor 500 includes an input event thread pool 502, a main thread pool 504, an output event thread pool 506 and a request queue 508. The input event thread pool 502 is connected to the receiver 210 and the request queue 508. The request queue 508 is connected to the input event thread pool 502, the main thread pool 504, and the output event thread pool. The main thread pool 504 is connected to the request queue 508. The output event thread pool 506 is connected to the request queue 508 and the transmitter 212. The request processor 500 may be software code stored in a memory and executed by a computer processor, although the invention is not limited to this embodiment. In an exemplary embodiment, the memory and computer processor are components of the room server 110. The software instructions may be stored on a computer-readable medium, such as a floppy disk, CD ROM, or any other appropriate storage medium. The connections of the components in the request processor 500 may be logical connections defined by the software code.

The receiver 210 sends input requests received from client 102 to the request processor 500. The input requests are sent to the input event thread pool 502 for processing. Input requests include request that require an immediate response and long term actions. Input requests that require an immediate response are created to handle incoming network traffic sent via TCP. Input requests that are long term actions are created to handle incoming network traffic sent via UDP, if the connection supports UDP as a transmission protocol.

Output requests are sent to the output event thread pool 506 for processing. Output requests are created to handle outbound data sent via UDP, if the connection supports UDP as a transmission protocol. In processing the output request, the output event thread pool 506 generates an output event. This event calls one or more transmitters 212 to send outbound data to clients 102.

Internal requests are used to perform tasks that are internal to the room server 110. Internal requests consist of retransmission of audio and video within the room server 110, as well as other tasks which are not appropriate to handle in an input or output request because of potential locking or blocking issues. Internal requests are stored in request queue 508, and are dispatched to the main thread pool 504 as threads become available.

FIG. 6 is a flow chart of dynamic data transmission according to an exemplary embodiment of the present invention. The process of dynamic data transmission is facilitated by both the client 102 and room server 110 to ensure minimum latency in the transmission and receipt of multimedia data. When a client 102 initiates a conferencing session by logging-in through an entry server 106, a bandwidth regulator determines 602 the current bandwidth and latency for outgoing and incoming multimedia transmissions. The clients 102 and room servers 110 each contain bandwidth regulators, which, in an exemplary embodiment, are implemented in software. Based on the bandwidth and latency information, the bandwidth regulator determines 604 the optimal packet size and optimal packet interval for each connection. The room server 110 records 606, in a journal, table, or other similar data structure, the packet size and departure time for the next packet sent by transmitter 212. The client 102 sends 606 the next packet and records, in a journal, table, or other similar data structure, the packet size and departure time for this packet.

In one embodiment, the sender (either the room server 110 or the client 102) then determines 608 whether there is more data to be sent to the receiver. If there is no more data to be sent, the process ends. If there is additional data to be sent, then the bandwidth regulator updates 610 the journal by removing records from that journal for each receipt received from the inbound multimedia stream. At the room server 110, the receipts will be accepted at receiver 210. At client 102, the receipts will be accepted at receiver 202. The bandwidth regulator also removes records from the journal for packets that have been lost. The bandwidth regulator then determines 612 the expected arrival time for the receipts corresponding to each remaining entry in the journal. The expected arrival time is determined by using the departure time of the packet, the latency, and the outbound and inbound packet size and bandwidth.

The bandwidth regulators at client 102 and room server 110 then uses the expected arrival time to determine 614 whether any journaled packets are overdue. If there are overdue packets, then the bandwidth regulator enters 616 a mode in which transmitter 204, 212 sends only audio data. Since the audio data requires lower bandwidth for transmission than video and audio data combined, the latency of the transmission will decrease if the data is limited to only audio. If there are no overdue packets, then the bandwidth regulator enters 618 a mode in which transmitter 204, 212 sends both audio and video data. If there is enough available bandwidth in the connection to handle video and audio data, there will be no overdue packets and the bandwidth regulator will allow the transmission of both audio and video data. The result of switching between these two modes is that, for lower bandwidth connections, audio data is sent continuously with intermittent transmissions of video data. Once either the audio mode or audio and video mode has been entered, the client 102 or room server 110 sends 606 the next packet and records the packet size and departure time for this packet.

### Bandwidth Optimizer

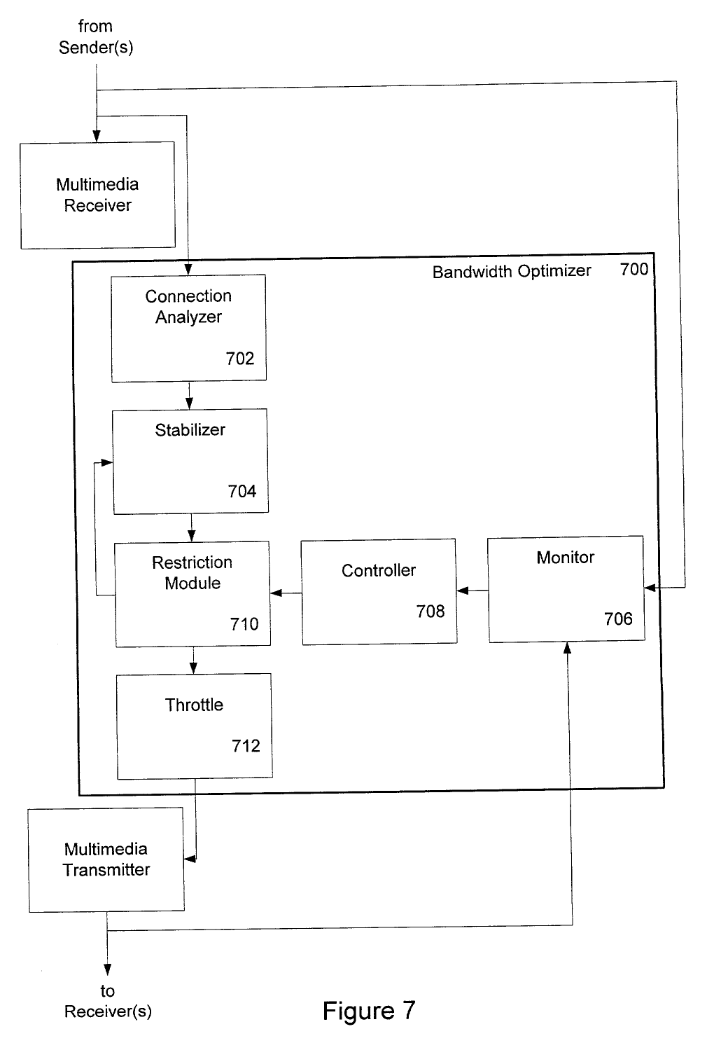

FIG. 7 is a block diagram of an exemplary embodiment of a bandwidth optimizer 700. The bandwidth optimizer adjusts the transmission rate while monitoring actual round trip transmission times and rate of packet loss in order to determine the most efficient transmission rate. In an exemplary embodiment, this efficient transmission rate is defined as the maximum rate at which data can be transmitted without a substantial increase in either network latency or packet loss. In an exemplary implementation, the bandwidth optimizer 700 and the components of the bandwidth optimizer 700 described below are implemented in software. If UDP is the protocol used for the transmission, then this software may be located at both the client 102 and the room server 106. If TCP is the protocol used for the transmission, then the software is located at only the client 102. The bandwidth optimizer 700 continually monitors outgoing and incoming multimedia traffic for backlogs in data. If the bandwidth optimizer detects a backlog, it lowers the rate of data transmission by decreasing the packet size and transmission interval for the data. If the bandwidth optimizer detects no backlog, then it gradually increases the rate of data transmission until a backlog is again detected. This process is described in greater detail below.

This embodiment of bandwidth optimizer 700 includes a connection analyzer 702, a stabilizer 704, a monitor 706, a controller 708, a restriction module 710, and a throttle 712. The connection analyzer 702 determines maximum inbound and outbound transmission rates and network latency. The client 102 may manually establish the transmission rates or may request that the connection analyzer 702 automatically detect the input and output transmission rates and network latency. In an exemplary arrangement, these three variables are determined once, prior to sending or receiving multimedia data.

The stabilizer 704 adjusts the inbound and outbound “current ceiling” transmission rates. The current ceiling transmission rates may differ from the maximum transmission rates that are determined by the connection analyzer 702. The current ceiling transmission rates are initially set to the maximum transmission rates determined by the connection analyzer 702. The stabilizer 704 adjusts the current ceiling transmission rates by determining the percentage of time that the connection appeared to be backlogged over a predetermined period of time. For instance, in an exemplary embodiment, the stabilizer 704 may determine the percentage of time that the connection appeared to be backlogged over the previous two seconds. If this percentage of time is zero and the current ceiling transmission rates are less than the maximum transmission rates, then the current ceilings are increased by a given percentage. For example, this increase may be two percent. If the transmission rate increases, no further increase (or decrease) will be permitted for a given period of time after the increase. As an example, no further increase or decrease could be permitted for 750 ms after the increase. If the percentage of backlogged time is greater than 25, then the current ceilings are decreased by the percentage of time that the connection appeared to be backlogged. If the ceilings are decreased, then no further decrease (or increase) will be permitted for a given period of time, e.g., two seconds. This adjustment is based on input from the connection analyzer 702 and from the restriction module 710. In an exemplary embodiment, the restriction module 710 sends an indicator to the stabilizer 704 of the percentage of backlog detected in the last two seconds of transmission. The stabilizer 704 looks at the restriction journal to determine the percentage of time that the connection was backlogged. The stabilizer 704 sends the adjusted ceilings to the restriction module 710.

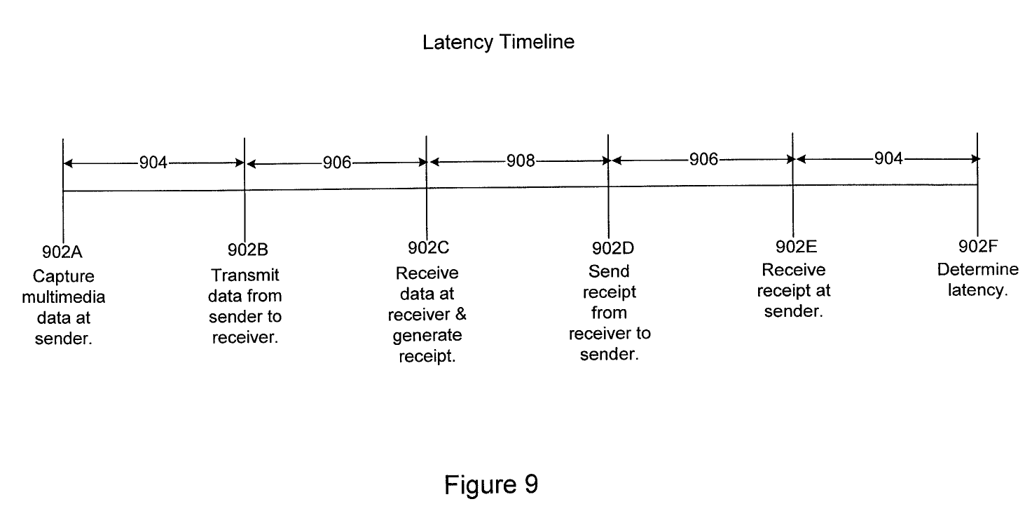

In an exemplary embodiment, the monitor determines the amount of backlog in milliseconds and sends this to the controller 708. The monitor 706 receives as inputs, the time that data packets are sent to remote receivers, the size of the data packets sent, the receipts sent by those remote receivers, which include the time that the data packets are actually received as well as a value for server latency, and the size of the incoming packet that contained the receipt. The monitor 706 uses the time that the data packets are sent and the known latency information to calculate when the data packet should have been received, and when the receipt for the data packet should be received. The determination of latency is discussed further below in the description of FIG. 9. To determine the amount of backlog in milliseconds, the monitor 706 keeps track of the time that both the data packets and the receipts for the data packets are expected to be received, and compares these times with the times that they are actually received. From this information, the monitor 706 can calculate the actual transmission rate. The monitor 706 determines the difference between the actual and expected transmission rates. This backlog time is sent to the controller 708.

In an exemplary embodiment, the controller 708 determines whether the backlog received from the monitor 706 is above a predetermined threshold. If the backlog is above the given threshold, the controller 708 sends a positive indicator to the restriction module 710. Otherwise, the controller 708 sends a negative indicator to the restriction module 710. For example, the threshold may be set at a thirty millisecond backlog and the controller 708 would send a positive indicator if the backlog were above this threshold.

The restriction module 710 receives the current ceiling transmission rates from the stabilizer 704 and the indicator from the controller 708. If the indicator is positive, then the restriction module restricts the current transmission rate to a predetermined minimum transmission rate. If the indicator is negative, then the restriction module uses the current ceiling transmission rate as the current transmission rate. The resulting current transmission rate is sent to the throttle 712. The restriction module also maintains a journal of restriction history. The journal may be a table or other similar data structure. This journal is examined in order to determine the percentage of backlog for the stabilizer 704.

In an exemplary embodiment, the throttle 712 receives a transmission rate from the restriction module 710. The throttle 712 uses the transmission rate to determine the optimal packet size and interval of packet transmission for outgoing and incoming data. The inbound interval will always equal outbound interval when using TCP as the transmission protocol. If UDP is used as the transmission protocol, then the inbound interval is determined by the throttle 712 on the remote sender.

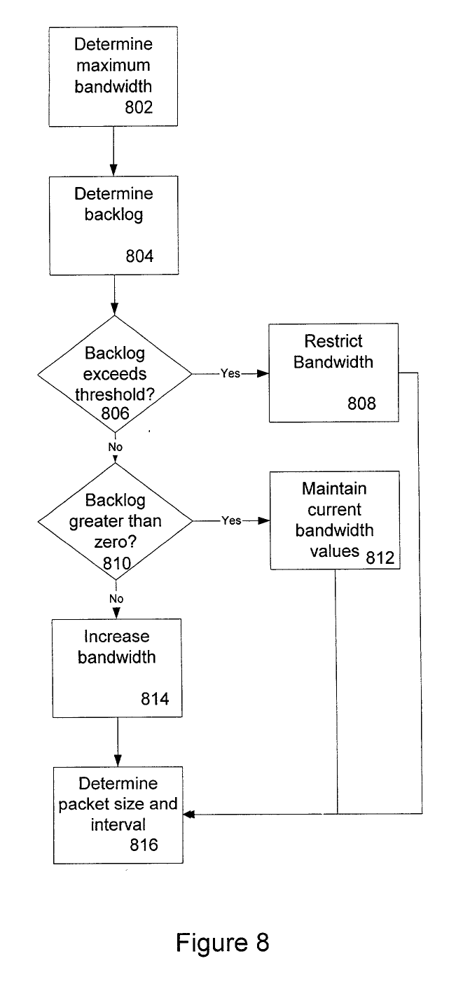

FIG. 8 is a flow diagram of an exemplary embodiment of the bandwidth optimizer process. The bandwidth optimizer 700 determines 802 the maximum current bandwidth. The monitor 706 in the bandwidth optimizer 700 determines 804 the current backlog. The controller 708 in step 806 determines whether the current backlog exceeds a predetermined threshold. If so, then the restriction module 710 restricts the current bandwidth values to the average transmission rate. If not, then the stabilizer 704 determines, in step 810, whether the backlog is greater than zero. If the backlog is greater than zero, then the bandwidth optimizer maintains the current bandwidth values. If there is no backlog, then the stabilizer 704 increases 814 the current bandwidth values by a predetermined amount. The throttle then adjusts the current packet size and transmission speed based on the transmission rate indicated by the current bandwidth values.

FIG. 9 is a depiction of an exemplary embodiment of a latency timeline 900 as used by the present invention to determine transmission latency. The bandwidth optimizer 700 uses time stamps to track the data as it travels from the point of generation to the multimedia display. As each data packet passes certain points 902 in the transmission path, the data packet is associated with a time stamp. The time stamp may be appended to the data packet itself or it may be associated with an identifier of the data packet and sent to a different location than the data packet. In an exemplary embodiment, each data packet is associated with a time stamp at point 902A when the data is captured at the sender. The sender may be either a client 102 or a server 104, depending on which direction the data packet is traveling. The data packet is also associated with a time stamp at point 902B when the sender transmits the data packets to the receiver. Like the sender, the receiver in this case may be either a client 102 or a server 104. The data packet is then associated with a time stamp at point 902C when the receiver receives the data and generates a receipt, point 902D when the receiver sends the receipt to the sender, point 902E when the sender receives the receipt, and point 902F when the sender determines the latency for the data packet.

The latency that occurs between points 902A and 902B, and between points 902E and 902F is attributable to the sender. The latency that occurs between points 902B and 902C, and points 902D and 902E is attributable to the network. Finally, the latency that occurs between points 902C and 902D is attributable to the receiver. Thus, by tracking the data packets throughout the transmission stream, the latency for the complete transmission can be determined. The monitor 706 then uses this latency information to determine the current backlog.

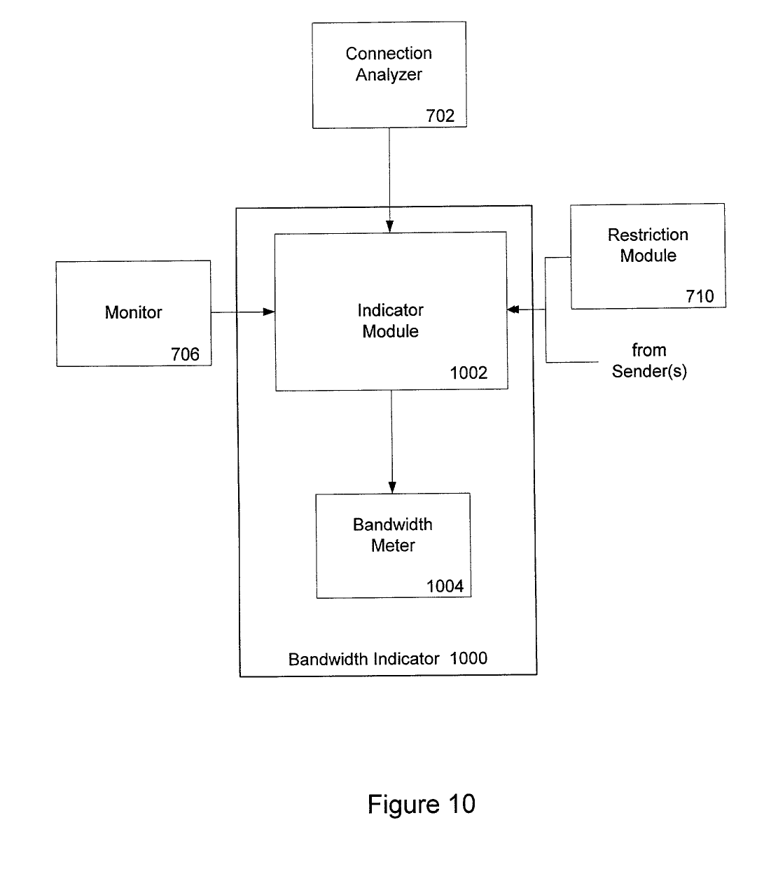

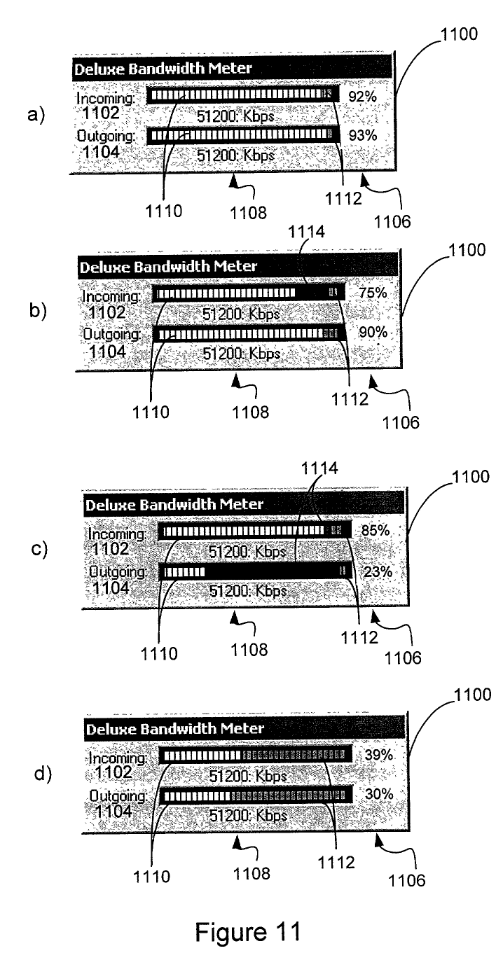

FIG. 10 is a block diagram depicting an exemplary embodiment of a bandwidth indicator as used by the present invention. The bandwidth indicator interfaces with the bandwidth optimizer to obtain information needed for a user interface. The user interface is described in greater detail in the discussion of FIG. 11, below. In an exemplary embodiment, the bandwidth indicator 1000 is implemented in software and includes an indicator module 1002 and a bandwidth meter 1004. The indicator module 1002 receives information from the bandwidth determination module 702, the monitor 706, and the restriction module 710 and outputs information to the bandwidth meter 1004. The bandwidth meter 1004 uses this information to create the user interface described in FIG. 11. The bandwidth determination module 702 sends the values of the maximum inbound and outbound bandwidths to the indicator module 1002. The monitor 706 sends inbound and outbound backlog information to the indicator module 1002. The backlog information is used to determine both the transmission rate for the data that was actually sent and the transmission rate that would be required to prevent a backlog. The restriction module 710 sends the outbound restriction rate to the indicator module 1002. The sender provides the inbound restriction rate to the indicator module 1002. If either rate has been restricted, then this lower rate is used as the scale for the bandwidth meter user interface. If the rates have not been restricted, then the maximum bandwidth received from the bandwidth determination module will be used as the scale for the user interface. The indicator module 1002 uses the rate information to provide inbound and outbound values to the bandwidth meter 1004. These values include the maximum transmission rate, the current transmission rate, and the rate required to maintain data flow without backlog.

FIG. 11 shows an exemplary embodiment of the user interface for the bandwidth meter. The bandwidth meter window 1100 includes an inbound bandwidth scale 1102 and an outbound bandwidth scale 1104. Each scale 1102, 1104 includes a horizontal histogram meter 1108 and a percentage value 1106. The percentage value 1106 is represented graphically on the horizontal histogram meter 1108. Each scale represents the maximum rate of transmission for multimedia data and may include three parts. The first part 1110 indicates the current rate of data transmission, the second part 1112 indicates the amount of available bandwidth, and the third part 1114 indicates the increase in rate required to maintain desired data flow without backlog.

FIG. 11a depicts a bandwidth meter indicating that the inbound and outbound transmission rates are close to maximum and that there is no backlog. FIG. 11b depicts a bandwidth meter indicating that the outbound transmission rate is close to maximum with no backlog, and that the inbound transmission rate is slower than desired, causing a slight backlog. FIG. 11c depicts a bandwidth meter indicating that the inbound transmission rate is just slightly lower than desired, and that the outbound transmission rate is significantly less than desired. This low transmission rate causes a large backlog as indicated by part 1114 of the histogram meter 1108. FIG. 11d depicts a bandwidth meter indicating that the inbound and outbound transmission rates are low in comparison with the maximum allowable rate of transmission and that there is no backlog.

### Microphone Queue

As depicted in FIG. 2, only one client 102 sends audio 216 at a time. In FIG. 2, client 102A is sending audio 216A, which is received by clients 102B and 102N. When a client is sending audio, that client has possession of the microphone. The microphone queue is a data structure implemented by the room server 106 to facilitate arbitration of the microphone. The client 102 at the front of the queue has possession of the microphone and it is this client that will be heard by the other clients in the room. Each client 102 has the option of making two requests: a request to talk and a request to interrupt. These requests are handled by the request processor 500 as described in the discussion of FIG. 5, above. When a client 102 makes a request to talk, that client is placed at the end of the microphone queue. When the client with possession of the microphone lets go of the microphone, that client is removed from the microphone queue allowing the next client in the queue to take possession of the microphone. When a client 102 makes a request to interrupt, that client is placed at the front of the microphone queue. That client thus, gains possession of the microphone and the rest of the clients including the previous possessor of the microphone maintain their order in the queue behind that client.

An exemplary embodiment of the user interface for the microphone queue 1202 includes two icons. One icon represents possession 1204 of the microphone and is displayed adjacent to the name of the client in possession of the microphone. The second icon represents placement 1206 in the microphone queue and is displayed adjacent to the names of the clients 1208 that have requested to talk. The order within the microphone queue is represented by the order of the client list within the user interface. Thus, the name of the client in possession of the microphone would be at the top of the list and would have the first icon displayed next to it. The name of the next client in line for the microphone would be next on the list and would have the second icon displayed next to it.

### Instant Messenger Integration

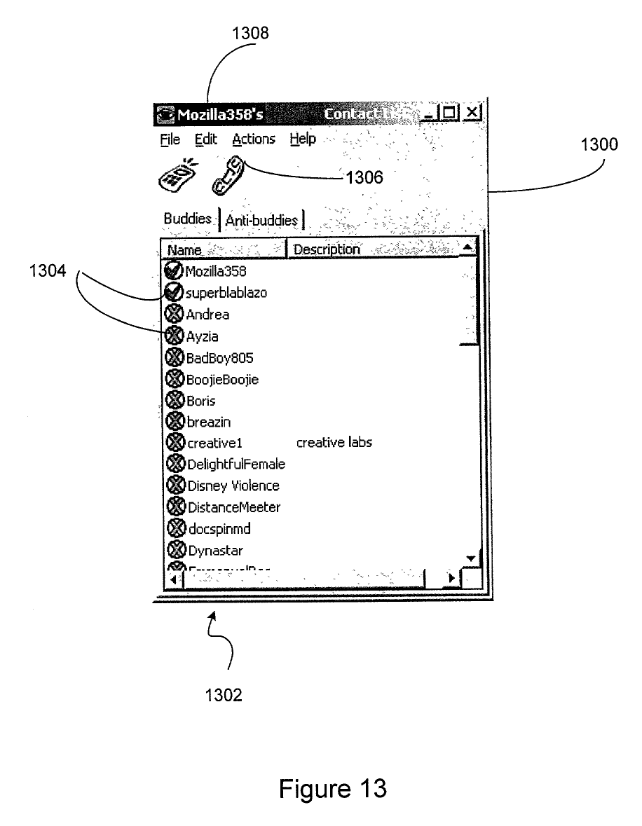

In one embodiment, the video teleconferencing system described in FIG. 1 includes one or more instant messenger servers connected to router 112. The instant messenger servers implement an instant meeting feature. This feature uses a user interface similar to currently available instant messenger programs as shown in FIG. 13. In this embodiment, each client can create a contact list 1300. The contact list 1300 is unique to the client 102 and is identified by the screen name 1308 of the client. In creating the contact list 1300, the client 102 may add the screen names of any number of other clients 102. These screen names are displayed in a list 1302. Next to each name is an icon 1304 that indicates whether or not each client 102 is signed in to the instant meeting service. In this embodiment, the client 102 indirectly requests the creation of a room by selecting one or more other clients 102 for participation in a meeting. To select the clients invited to participate, the requesting client may highlight the user names of the invited clients in the screen name list 1302. The requesting client then chooses the video call button 1306, which cues the instant messenger server to establish a new room and allow access to all the invited clients. The requesting client may then choose to begin the video call at which point, the requesting client enters the new room and the server sends invitations to the invited clients. As the invited clients accept the invitations, they also enter the new room.

When in the room, the clients 102 may exchange video, audio and text. On occasion, this exchange of information may create a conflict among the clients 102 participating in the meeting. These users then may register a complaint with the company that runs the video teleconferencing in the hopes of resolving the conflict. In order to resolve the conflict, the company may be required to conduct extensive amounts of research and may have to rely on only the statements of the clients made subsequent to the incident that resulted in the conflict. The evidence journal feature prevents this from happening. If a client 102 wishes to complain about another client 102, then the complaining client can activate the evidence journal. Once activated, the evidence journal records the most recent audio, video and text. For example, the journal may capture five minutes of text, 5 seconds of audio, and 10 seconds of video. The time interval is predetermined and may vary based on the needs of the company.

Having fully described an exemplary embodiment of the invention and various alternatives, those skilled in the art will recognize, given the teachings herein, that numerous alternatives and equivalents exist that do not depart from the invention. It is therefore intended that the invention not be limited by the foregoing description, but only by the appended claims.

We claim:

1. A computer implemented method for sending and receiving multimedia transmissions between two or more clients, the method comprising the steps of:
determining a maximum inbound and outbound transmission rate for a connection between a client and a server;
determining a latency value for transmissions over the connection;
determining a backlog value for transmissions over the connection; and
varying the inbound and outbound rates of transmission over the connection responsive to the backlog value and the latency value.

2. The computer implemented method of claim 1, wherein the multimedia transmissions are comprised of data packets and varying the rates of transmission is further comprised of:
varying the size of the data packets; and
varying the time interval between the transmission of each data packet.

3. The computer implemented method of claim 1, wherein varying the rate of transmission further comprises:
increasing the rate of transmission if there is no backlog and the rate of transmission is below the maximum transmission rate; and
decreasing the rate of transmission if the backlog is above a predetermined threshold.

4. The computer implemented method of claim 1, wherein the transmission originates at the client and terminates at the server.

5. The computer implemented method of claim 1, wherein the transmission originates at the server and terminates at the client.

6. A system for sending and receiving multimedia data transmissions between two or more clients, the system comprising:
a receiver for receiving the multimedia transmissions;
a transmitter for transmitting the multimedia transmissions at a variable transmission rate;
a bandwidth optimizer coupled to the transmitter, the bandwidth optimizer determining a maximum inbound and outbound transmission rate, monitoring for a backlog in the multimedia data transmissions, and varying the transmission rate responsive to the backlog.

7. The system of claim 6, wherein the multimedia transmissions are comprised of data packets and varying the rate of transmission is further comprised of:
varying the size of the data packets; and
varying the time interval between the transmission of each data packet.

8. The system of claim 6, wherein varying the rate of transmission further comprises:
increasing the rate of transmission if there is no backlog and the rate of transmission is below the maximum transmission rate; and
decreasing the rate of transmission if the backlog is above a predetermined threshold.

9. The system of claim 6, wherein the transmission originates at a client and terminates at a server.

10. The system of claim 6, wherein the transmission originates at a server and terminates at a client.

11. A computer program product stored on a computer readable medium for sending and receiving multimedia transmissions between two or more clients, the computer program product controlling a processor coupled to the medium to perform the operations of:
determining a maximum inbound and outbound transmission rate for a connection between a client and a server;
determining a latency value for transmissions over the connection;
determining a backlog value for transmissions over the connection; and
varying the inbound and outbound rates of transmission over the connection responsive to the backlog value and the latency value.

12. The computer program product of claim 11, wherein the multimedia transmissions are comprised of data packets and varying the rates of transmission is further comprised of:
varying the size of the data packets; and
varying the time interval between the transmission of each data packet.

13. The computer program product of claim 11, wherein varying the rate of transmission further comprises:
increasing the rate of transmission if there is no backlog and the rate of transmission is below the maximum transmission rate; and
decreasing the rate of transmission if the backlog is above a predetermined threshold.

14. The method of claim 11, wherein the transmission originates at the client and terminates at the server.

15. The method of claim 11, wherein the transmission originates at the server and terminates at the client.
